(19) United States
(12) Patent Application Publication
(10) Pub. No.: US 2003/0200401 A1
(43) Pub. Date: Oct. 23, 2003

(54) Microcomputer system automatically backing-up data written in storage medium in transceiver, and transceiver connected thereto

(75) Inventors: Shohei Moriwaki, Hyogo (JP); Yoshifumi Azekawa, Hyogo (JP); Osamu Chiba, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/310,829

(22) Filed: Dec. 6, 2002

(30) Foreign Application Priority Data
Apr. 17, 2002 (JP) 2002-115326

(51) Int. Cl. G06F 12/00

(52) U.S. Cl. 711/154

(57) ABSTRACT

A microcomputer system includes a transceiver used in Ethernet (R) and a microcomputer backing up data in the transceiver. The transceiver, upon receiving a request for data write in a primary storage medium from a host device, outputs an interruption request to the microcomputer. The microcomputer, upon receiving the interruption request, reads data written in the primary storage medium and writes the data in a second storage medium. Therefore, if the data written in the primary storage medium is lost due to a momentary power failure and the like, the data of the primary storage medium can be restored.

Microcomputer System Automatically Backing-up Data Written in Storage Medium in Transceiver, and Transceiver Connected Thereto

### BACKGROUND OF THE INVENTION

1. Field of the Invention

The present invention relates to a transceiver in Ethernet (R) transmitting/receiving data through a storage medium in response to a request from a host device, and more particularly to a microcomputer system automatically backing up data written in a storage medium in a transceiver as well as the transceiver used therefor.

2. Description of the Background Art

In recent years, various types of systems for transmitting/receiving data through a storage medium in response to a request from a host device have been developed. One example thereof includes a system employing an MDIO (Medium Dependent Input/Output) interface used in Ethernet (R).

FIG. 1 illustrates data transfer between a host device and an MDIO interface. The host device is connected to a plurality of systems having the MDIO interface mounted (hereinafter, simply referred to as “system”), to which systems different port addresses are allocated respectively. In addition, a storage medium included in the system is divided into a plurality of areas of several tens of words, and the respective areas are provided with different device addresses. By transmitting a port address and a device address, the host device can select a system and an area in a storage medium included in the system, and can access to a desired area.

When the host device reads data from a system, the host device transmits to a system, an instruction code 101 indicating data read, a port address 102 and a device address 103. Each system determines whether or not access is made to that system, with reference to port address 102. If the access is directed to that system, the system, referring to device address 103, reads data 105 from an area in the storage medium corresponding to device address 103, and transmits the data to the host device. After transmission of device address 103, the host device needs to obtain data 105 before a turnaround time 104 expires. Usually, this turnaround time 104 is defined as 2 cycles. For example, if 2 MHz clock is used, the system should return data 105 to a host computer within 1 μs.

If the host device writes data in the storage medium in the system, the host device sequentially transmits instruction code 101 indicating data write, port address 102, device address 103 and data 105, and the system corresponding to port address 102 writes data 105 in an area in the storage medium corresponding to device address 103.

As described above, after transmitting device address 103, the host device needs to obtain data 105 before turnaround time 104 expires. Therefore, a register capable of fast access is generally used as a storage medium.

Meanwhile, contents in the storage medium should be backed up so as not to be lost in an event such as a momentary power failure and the like. In a conventional system employing an MDIO interface, however, such a scheme has not been provided.

### SUMMARY OF THE INVENTION

An object of the present invention is to provide a microcomputer system capable of restoring data even if the data written in a transceiver is lost.

An another object of the present invention is to provide a microcomputer system capable of backing up data without a special processing by a transceiver.

According to one aspect of the present invention, a microcomputer system includes a transceiver used in Ethernet (R) and a microcomputer backing up data in the transceiver. The transceiver includes an interface transmitting/receiving data to/from outside; a primary storage medium in which the data received from outside through the interface is written; and a decoder decoding a request received from outside through the interface and outputting an interruption request to the microcomputer if the request is made for data write in the primary storage medium. The microcomputer includes a secondary storage medium, and a processor reading the data written in the primary storage medium and writing the data in the secondary storage medium, upon receiving the interruption request.

Upon receiving the interruption request, the processor reads the data written in the primary storage medium and writes the data in the secondary storage medium. Therefore, even if the data written in the primary storage medium is lost due to a momentary power failure and the like, the data can be restored by transferring the data held in the secondary storage medium to the primary storage medium.

In addition, the data is backed up if only the transceiver outputs the interruption request to the microcomputer. Therefore, the data can be backed up without a special processing by the transceiver.

According to another aspect of the present invention, a microcomputer system includes a transceiver used in Ethernet (R), and a microcomputer backing up data in the transceiver. The transceiver includes an interface transmitting/receiving data to/from outside; a primary storage medium in which the data received from outside through the interface is written; and a decoder decoding a request received from outside through the interface and outputting an interruption request to the microcomputer if the request is made for data write in the primary storage medium. The microcomputer includes a processor reading the data written in the primary storage medium and writing the data in the secondary storage medium provided outside, upon receiving the interruption request.

Since the secondary storage medium is provided outside the microcomputer, a capacity and access speed of the secondary storage medium can be determined in accordance with the system. Thus, versatility of the microcomputer system can be improved.

According to yet another aspect of the present invention, a transceiver transmitting/receiving data to/from a host device is provided. The transceiver includes an interface connected to a first bus and transmitting/receiving data to/from outside; a storage medium in which the data received from the first bus through the interface can be written, and from which the written data can be read by the microcomputer through a second bus different from the first bus; and a decoder receiving an instruction code and an address signal through the interface, determining if the instruction code indicates data write and if the address signal designates an area in the storage medium, and outputting an interruption request to the microcomputer.

Therefore, the microcomputer can be notified of data write in a prescribed area in the storage medium, and can read the data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates data transfer between a host device and an MDIO interface.

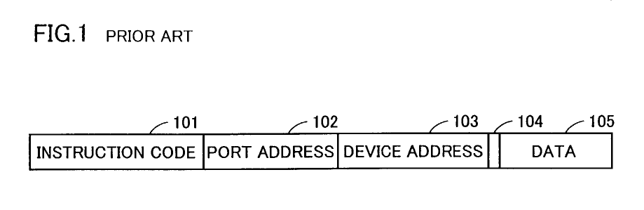

FIG. 2 is a block diagram schematically showing a configuration of a microcomputer system in a first embodiment of the present invention.

FIG. 3 is a flowchart illustrating a processing procedure of the microcomputer system in the first embodiment of the present invention.

FIG. 4 is a block diagram schematically showing a configuration of a microcomputer system in a second embodiment of the present invention.

### DESCRIPTION OF THE PREFERRED EMBODIMENTS

(First Embodiment)

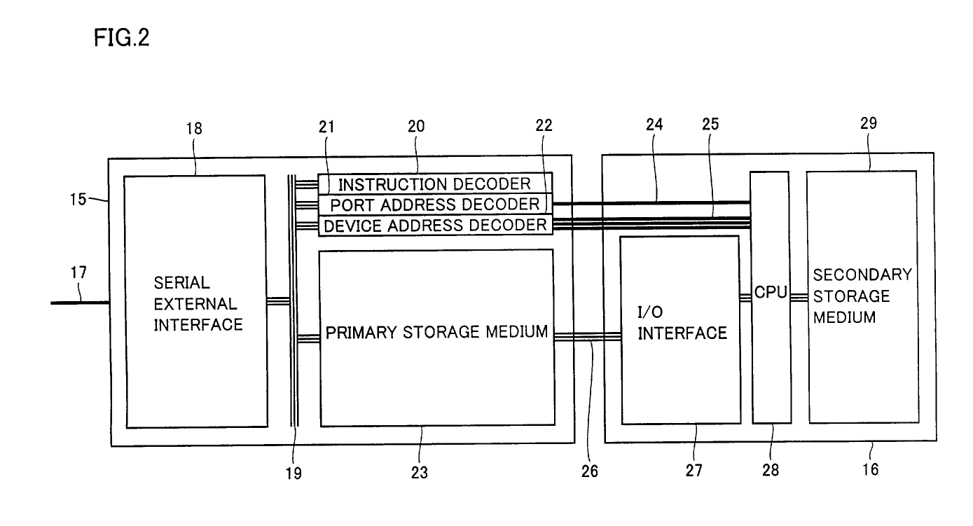

FIG. 2 is a block diagram schematically showing a configuration of a microcomputer system in a first embodiment of the present invention. The microcomputer system includes a transceiver 15 transmitting/receiving data in response to a request from a host device (not-shown), and a microcomputer 16 backing up data written in transceiver 15. Though a configuration in which transceiver 15 and microcomputer 16 are fabricated with one semiconductor chip is described, transceiver 15 and microcomputer 16 may be fabricated respectively with one semiconductor chip.

Transceiver 15 includes a primary storage medium 23 with a high access speed; a serial external interface 18 converting serial data received from a serial external interface in the host device (not shown) to parallel data, converting data read from primary storage medium 23 to serial data, and transmitting the data to the serial external interface in the host device; an instruction decoder 20 decoding an instruction code 101 received from serial external interface 18; a port address decoder 21 decoding a port address 102 received from serial external interface 18; and a device address decoder 22 decoding a device address 103 received from serial external interface 18.

Microcomputer 16 includes a CPU (Central Processing Unit) 28 performing backup processing of data written in primary storage medium 23; an I/O (Input/Output) interface 27 reading the data from primary storage medium 23 through a data bus 26, outputting the data to CPU 28, and writing the data output from CPU 28 in primary storage medium 23 through data bus 26; and a secondary storage medium 29 having contents of first storage medium 23 as a backup.

Primary storage medium 23 is implemented by a register capable of high-speed access and having small capacity, an SRAM (Static Random Access Memory) or the like.

Secondary storage medium 29 is implemented by a non-volatile memory such as a flash memory. The reason for using a rewritable, nonvolatile memory such as a flash memory is as follows. Even in an event of a momentary power failure and the like, or if the power is switched off, the data can be held. Thus, by rewriting and updating the data, resume with the latest data will be possible.

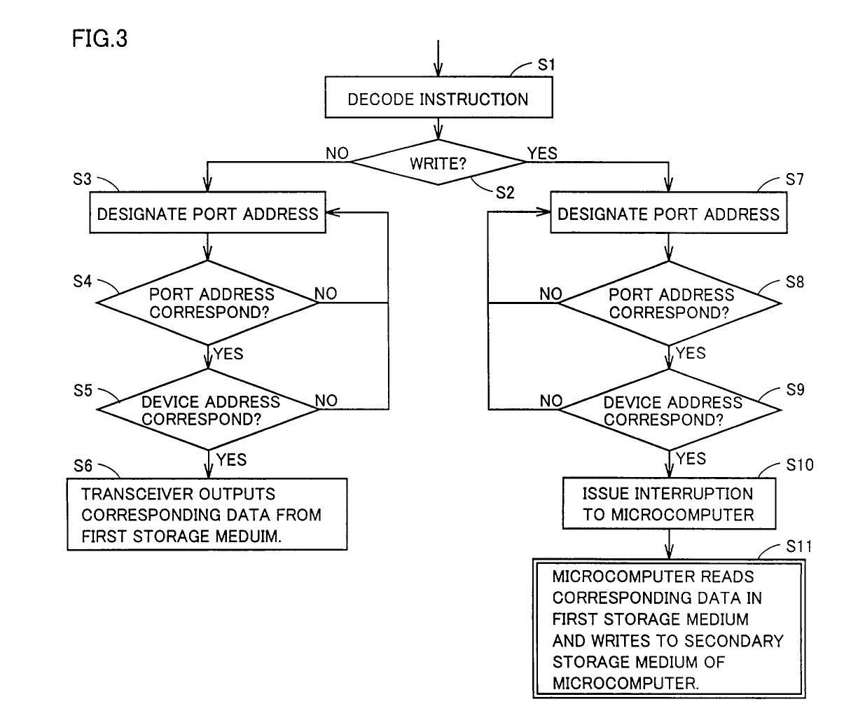

FIG. 3 is a flowchart illustrating a processing procedure of the microcomputer system in the first embodiment of the present invention. Serial external interface 18, upon receiving instruction code 101 from the host device through a serial bus 17, transfers instruction code 101 to instruction decoder 20 through an internal bus 19. Instruction decoder 20, upon receiving instruction code 101 from serial external interface 18, decodes instruction code 101 (S1), and determines whether or not the instruction code 101 indicates data write (S2).

If instruction code 101 indicates data read (S2, No), serial external interface 18 designates port address 102 to port address decoder 21 (S3). Port address decoder 21 decodes port address 102 received from serial external interface 18, and determines whether or not port address 102 corresponds to primary storage medium 23 (S4).

If port address 102 does not correspond to primary storage medium 23 (S4, No), the process will return to step S3, to wait for designation of port address 102. If port address 102 corresponds to primary storage medium 23 (S4, Yes), device address decoder 22 receives device address 103 from serial external interface 18, decodes device address 103, and determines whether or not device address 103 corresponds to an area in primary storage medium 23 (S5).

If device address 103 does not correspond to an area in primary storage medium 23 (S5, No), the process will return to step S3, to wait for designation of port address 102. If device address 103 corresponds to an area in primary storage medium 23 (S5, Yes), the corresponding data will be read from primary storage medium 23, and output to serial external interface 18 (S6). Serial external interface 18 transmits data received from primary storage medium 23 to the host device through serial bus 17.

If instruction code 101 indicates data write (S2, Yes), serial external interface 18 designates port address 102 to port address decoder 21 (S7). Port address decoder 21 decodes port address 102 received from serial external interface 18, and determines whether or not port address 102 corresponds to primary storage medium 23 (S8).

If port address 102 does not correspond to primary storage medium 23 (S8, No), the process will return to step S7, to wait for designation of port address 102. If port address 102 corresponds to primary storage medium 23 (S8, Yes), device address decoder 22 receives device address 103 from serial external interface 18, decodes device address 103, and determines whether or not device address 103 corresponds to an area in primary storage medium 23 (S9).

If device address 103 does not correspond to an area in primary storage medium 23 (S9, No), the process will return to step S7, to wait for designation of port address 102. If device address 103 corresponds to an area in primary storage medium 23 (S9, Yes), device address decoder 22 outputs an interruption request to CPU 28 in microcomputer 16 (S10).

When CPU 28 receives the interruption request from device address decoder 22, CPU 28 refers to a decoded result 24 of port address 102 output from port address decoder 21 and a decoded result 25 of device address 103 output from device address decoder 22, reads corresponding data from primary storage medium 23 through data bus 26 and I/O interface 27, and writes the data in secondary storage medium 29 (S11).

When the data stored in primary storage medium 23 is lost and CPU 28 writes back the data backed up in secondary storage medium 29 in the primary storage medium, CPU 28 reads the corresponding data from secondary storage medium 29, and writes the data in an appropriate area in primary storage medium 23 through I/O interface 27 and data bus 26.

In the above description, though a configuration for two address types, that is, port address 102 and device address 103, has been discussed, a microcomputer system can similarly be implemented with a configuration for three or more address types.

As described above, according to a microcomputer system in the present embodiment, when CPU 28 receives an interruption request from device address decoder 22, the corresponding data will be read from primary storage medium 23, and written in secondary storage medium 29. Therefore, the data can be restored even when the data stored in primary storage medium 23 is lost due to a momentary power failure and the like.

In addition, microcomputer 16 automatically backs up the data, upon receiving an interruption request from device address decoder 22. Accordingly, transceiver 15 can transmit/receive data in a conventional manner, without special processing.

Moreover, as the microcomputer system including CPU 28 can be fabricated with one chip, the interface can be implemented with low cost. Further, as the microcomputer system is embedded with CPU 28, other peripheral circuits controlled by CPU 28 can also be embedded on the same chip. Therefore, a highly extensible and flexible system can be implemented. By modifying a program executed by CPU 28, an interface complying with each standard can be implemented.

Furthermore, when serial external interface 18 is replaced by a parallel interface to transmit/receive data to/from the host device through a parallel bus, time required for data transfer with the host device can be shortened.

(Second Embodiment)

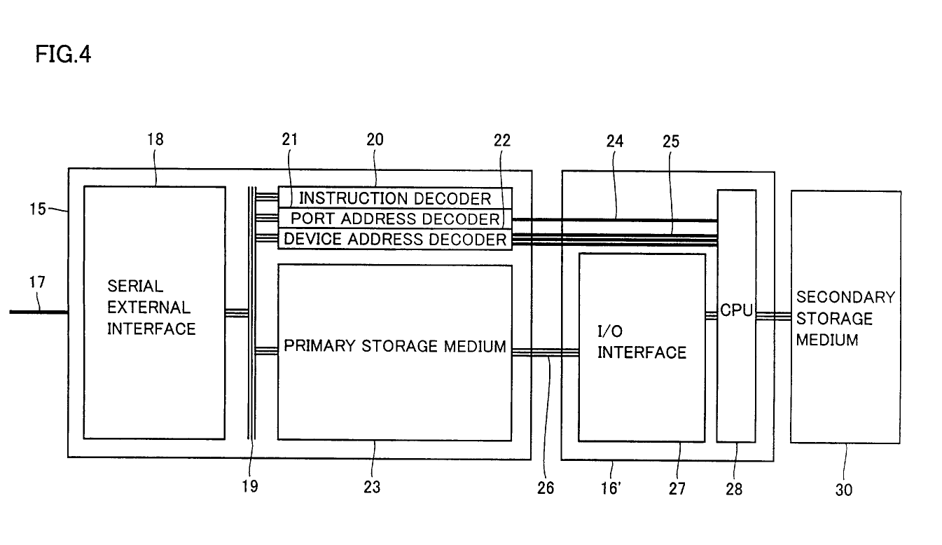

FIG. 4 is a block diagram schematically showing a configuration of a microcomputer system in a second embodiment of the present invention. The microcomputer system includes a transceiver 15 transmitting/receiving data in response to a request from a host device (not shown), and a microcomputer 16′ backing up data written in transceiver 15 in a secondary storage medium 30 provided outside. Secondary storage medium 30 is fabricated with a semiconductor chip different from any of those for transceiver 15 and microcomputer 16′. Note that a portion having the same configuration and function as in the first embodiment will be denoted by the same reference character.

Microcomputer 16′ includes a CPU 28 performing backup processing of the data written in primary storage medium 23; and an I/O interface 27 reading the data from primary storage medium 23 through a data bus 26, outputting the data to CPU 28, and writing the data output from CPU 28 in primary storage medium 23 through data bus 26.

Secondary storage medium 30 provided outside microcomputer 16′ is constituted of a non-volatile memory such as a flash memory.

When CPU 28 receives an interruption request from a device address decoder 22, CPU 28 refers to a decoded result 24 of a port address 102 from a port address decoder 21 and a decoded result 25 of a device address 103 from device address decoder 22, reads corresponding data from primary storage medium 23 through I/O interface 27 and data bus 26, and writes the data in secondary storage medium 30 provided outside microcomputer 16′.

When the data stored in primary storage medium 23 is lost and CPU 28 writes back the data backed up in secondary storage medium 30 in the primary storage medium, CPU 28 reads the corresponding data from secondary storage medium 30, and writes the data in an appropriate area in primary storage medium 23 through I/O interface 27 and data bus 26.

As described above, a microcomputer system according to the present embodiment has secondary storage medium 30 provided outside microcomputer 16′. Therefore, a storage medium having any given capacity and access speed can be connected, whereby versatility of the microcomputer system can be improved, in addition to an effect described in the first embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A microcomputer system comprising a transceiver used in a network and a microcomputer backing up data in said transceiver; wherein
said transceiver includes
an interface transmitting/receiving data to/from outside,
a primary storage medium in which the data received from outside through said interface are written, and
a decoder decoding a request received from outside through said interface and outputting an interruption request to said microcomputer if the request is made for data write in said primary storage medium; and
said microcomputer includes
a secondary storage medium and
a processor reading the data written in said primary storage medium and writing the data in said secondary storage medium, upon receiving said interruption request.

2. The microcomputer system according to claim 1, wherein
said decoder includes
an instruction decoder decoding an instruction code received from outside through said interface,
a port address decoder decoding a port address received from outside through said interface, and
a device address decoder decoding a device address received from outside through said interface, and outputting the interruption request to said microcomputer if a decoded result corresponds to said primary storage medium.

3. The microcomputer system according to claim 2, wherein
said processor refers to the decoded results from said port address decoder and said device address decoder upon receiving said interruption request, reads data from said primary storage medium, and writes the data in said secondary storage medium.

4. The microcomputer system according to claim 1, wherein
said interface serially transmits/receives data.

5. A microcomputer system comprising a transceiver used in a network and a microcomputer backing up data in said transceiver; wherein
said transceiver includes
an interface transmitting/receiving data to/from outside,
a primary storage medium in which the data received from outside through said interface are written, and
a decoder decoding a request received from outside through said interface and outputting an interruption request to said microcomputer if the request is made for data write in said primary storage medium; and
said microcomputer includes a processor reading the data written in said primary storage medium and writing the data in a secondary storage medium provided outside, upon receiving said interruption request.

6. The microcomputer system according to claim 5, wherein
said decoder includes
an instruction decoder decoding an instruction code received from outside through said interface,
a port address decoder decoding a port address received from outside through said interface, and
a device address decoder decoding a device address received from outside through said interface, and outputting the interruption request to said microcomputer if a decoded result corresponds to said primary storage medium.

7. The microcomputer system according to claim 6, wherein
said processor refers to the decoded results from said port address decoder and said device address decoder upon receiving said interruption request, reads data from said primary storage medium, and writes the data in said secondary storage medium.

8. The microcomputer system according to claim 5, wherein
said interface serially transmits/receives data.

9. A transceiver transmitting/receiving data to/from a host device, comprising:
an interface connected to a first bus and transmitting/receiving data to/from outside;
a storage medium in which the data received from said first bus through said interface is written, and from which said written data can be read by a microcomputer through a second bus different from said first bus; and
a decoder receiving an instruction code and an address signal through said interface, determining if said instruction code indicates data write and if said address signal designates an area in said storage medium, and outputting an interruption request to said microcomputer.
